(19) United States
(12) Patent Application Publication
(10) Pub. No.: US 2025/0335468 A1
(43) Pub. Date: Oct. 30, 2025

(54) Dynamically Generating Descriptions Using a Multi-Modal Large-Language Model

(71) Applicant: Maplebear Inc., San Francisco, CA (US)

(72) Inventors: Jonathan Gu, San Francisco, CA (US); Matias Cersosimo, Redwood City, CA (US); Ying Li, San Francisco, CA (US); Shishir Kumar Prasad, San Ramon, CA (US); Elizabeth Reichert, Creve Coeur, MO (US); Rajeshkumar Swaminathan, San Francisco, CA (US); Jiachuan He, San Francisco, CA (US)

(21) Appl. No.: 19/193,828

(22) Filed: Apr. 29, 2025

Related U.S. Application Data
(60) Provisional application No. 63/640,858, filed on Apr. 30, 2024.

(51) Int. Cl. G06F 16/28

(52) U.S. Cl. CPC G06F 16/285

(57) ABSTRACT

An online system generates text-based tags for item sources to dynamically generate customized clusters of the item sources for a user. The online system selects a set of item categories within the taxonomy based on interaction rate data of users with the item source. The online system uses these selected categories to generate tags for the item source. The online system generates a prompt for an LLM to generate an item source cluster for a set of item sources. The prompt includes the generated tags for the item sources and instructions on how to select item sources to include in the cluster based on the tags. The online system receives a response from the LLM that specifies which item sources to include in the item source cluster and the online system transmits instructions to a client device to present the item source cluster in a user interface.

### CROSS REFERENCE TO RELATED APPLICATIONS

This application claims the benefit of U.S. Provisional Patent Application Ser. No. 63/640,858, filed Apr. 30, 2024, which is incorporated by reference.

### BACKGROUND

An online system selects content to present to a user and presents that content to the user through a client device. In some cases, the online system may categorize content into themed groupings and display the content together. For example, the online system may create a grouping of item sources relating to a particular activity that provide items in which users may be interested in that activity. Online systems commonly use a rules-based approach to create these themed groupings because machine-learning solutions are less effective in this context. Specifically, because groupings are commonly displayed with a title or description of the theme of the group, these descriptions should be human-understandable to be effective. Machine-learning models are not effective at generating human-understandable descriptions, so online systems commonly rely on hard-coded rules that specify exactly which content to specify and exactly which descriptions to include with the content. While these hard-coded rules are effective in the narrow cases for which they have been generated, their rigidity does not allow for broad user-based flexibility, which limits their utility.

### SUMMARY

In accordance with one or more aspects of the disclosure, an online system generates text-based tags for item sources to dynamically generate customized clusters of the item sources for a user. The online system generates the tags for an item source using an item taxonomy, which is a hierarchical data structure that describes categories of items associated with an item source at various levels of generality. For example, a root node of the taxonomy may represent the full set of items in the taxonomy, leaf nodes may represent individual items, and the intermediary levels in the taxonomy may represent categories of items at different levels of breadth.

The online system selects a set of item categories within the taxonomy based on interaction rate data of users with the item source. Interaction rate data represents a rate at which users interact with items of an item source within a time period, and the online system uses the interaction rate data of categories of items within the item taxonomy to select a set of categories that are representative of the item source. For example, the online system may select a set of categories within certain levels of generality within the taxonomy with high interaction rates (e.g., above a threshold value). The online system uses these selected categories to generate tags for the item source. For example, the online system may use text data describing the categories to generate tags or may prompt a large language model (LLM) to generate the tags based on source data associated with the item source or item data associated with the items in the categories.

The online system generates a prompt for an LLM based on the generated tags. The prompt instructs the LLM to generate an item source cluster for a set of item sources, where the item source cluster is a set of item sources to display as content to a user. The prompt includes the generated tags for the item sources and instructions on how to select item sources to include in the cluster based on the tags. The prompt may further instruct the LLM to generate a description of the item source cluster or of the item sources within the cluster. For example, the prompt may instruct the LLM to generate a title or a short summary of the item source cluster.

The online system receives a response from the LLM that specifies which item sources to include in the item source cluster and the online system transmits instructions to a client device to present the item source cluster in a user interface. The client device may display the item source cluster in a horizontal carousel user interface element or in a banner user interface element, and may allow the user to interact with item sources through the presented item source cluster.

By generating tags for item sources and using the tags to prompt an LLM to generate an item source cluster, the online system improves the technical field of programmatically selecting customized content for presentation to a user. Specifically, the online system leverages an LLM's ability to generate a wide range of content based on many different input data types to generate the customized content. However, to prevent the LLM from hallucinating and to provide guidance on how to evaluate item sources, the online system generates the tags using the specific data structure of the item taxonomy and provides those tags to the LLM. The online system can thereby generate customized content without sacrificing relevance to its context.

### BRIEF DESCRIPTION

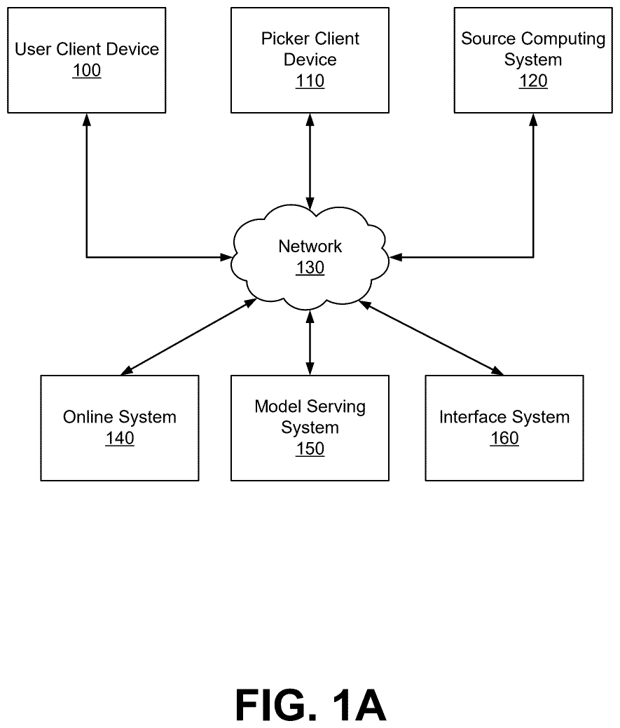

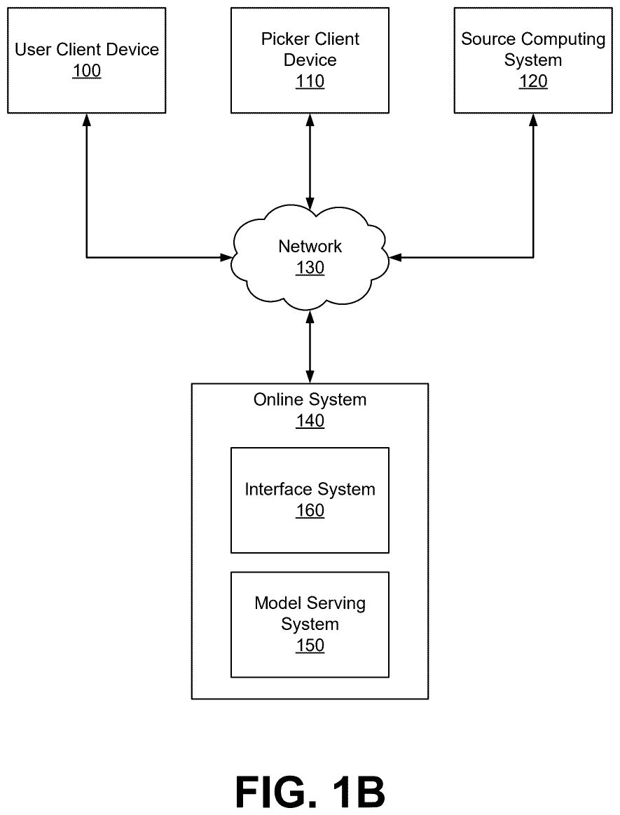

FIG. 1A illustrates an example system environment for an online system, in accordance with one or more embodiments.

FIG. 1B illustrates an example system environment for an online system, in accordance with one or more embodiments.

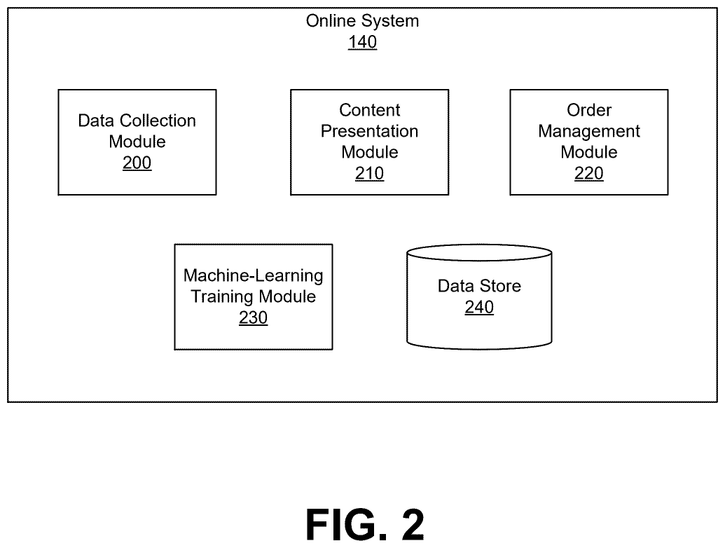

FIG. 2 illustrates an example system architecture for an online system, in accordance with some embodiments.

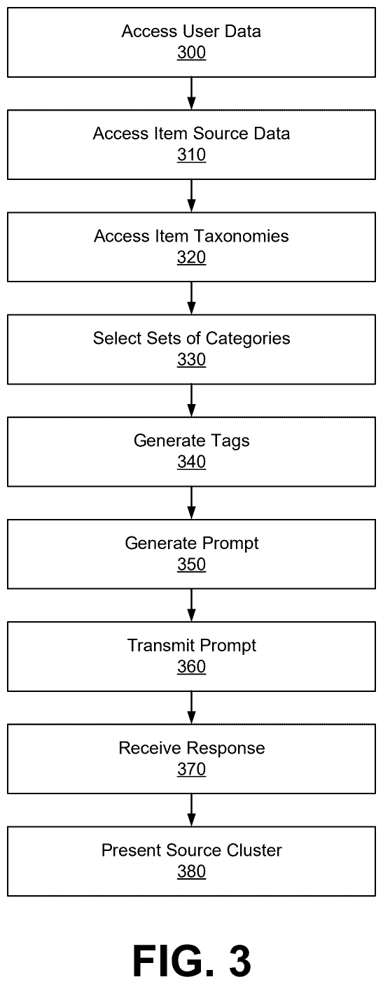

FIG. 3 is a flowchart for an example method of generating retailer cluster using a large language model, in accordance with some embodiments.

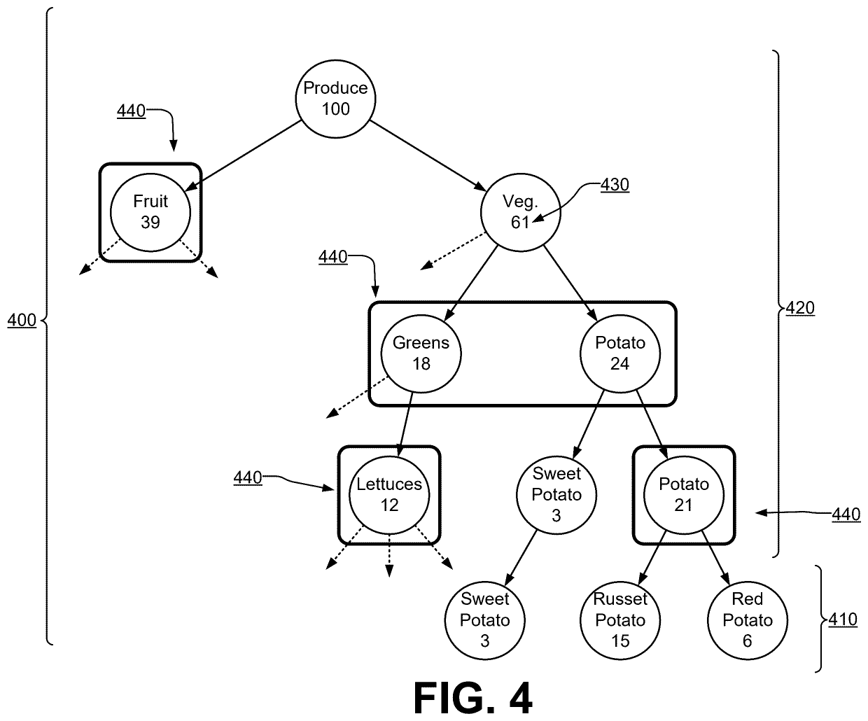

FIG. 4 illustrates example categories selected within an example item taxonomy, according to some embodiments.

### DETAILED DESCRIPTION

FIG. 1A illustrates an example system environment for an online system 140, in accordance with one or more embodiments. The system environment illustrated in FIG. 1A includes a user client device 100, a picker client device 110, a source computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1A, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” A “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

As an example, the online system 140 may allow a user to order groceries from a grocery store source. The user's order may specify which groceries they want to be delivered from the grocery store and the quantities of each of the groceries. The user's client device 100 transmits the user's order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140. The online system 140 is described in further detail below with regards to FIG. 2.

The model serving system 150 receives requests from the online system 140 to perform tasks using machine-learned models. The tasks include, but are not limited to, natural language processing (NLP) tasks, audio processing tasks, image processing tasks, video processing tasks, and the like. In one embodiment, the machine-learned models deployed by the model serving system 150 are models configured to perform one or more NLP tasks. The NLP tasks include, but are not limited to, text generation, query processing, machine translation, chatbots, and the like. In one embodiment, the language model is configured as a transformer neural network architecture. Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learning model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one embodiment, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 140 or one or more entities different from the online system 140. An LLM may be trained on a large amount of data from various data sources. For example, the data sources include websites, articles, posts on the web, and the like. From this massive amount of data coupled with the computing power of LLM's, the LLM is able to perform various tasks and synthesize and formulate output responses based on information extracted from the training data.

In one embodiment, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

In one embodiment, the task for the model serving system 150 is based on knowledge of the online system 140 that is fed to the machine-learned model of the model serving system 150, rather than relying on general knowledge encoded in the model weights of the model. Thus, one objective may be to perform various types of queries on the external data in order to perform any task that the machine-learned model of the model serving system 150 could perform. For example, the task may be to perform question-answering, text summarization, text generation, and the like based on information contained in an external dataset.

Thus, in one embodiment, the online system 140 is connected to an interface system 160. The interface system 160 receives external data from the online system 140 and builds a structured index over the external data using, for example, another machine-learned language model or heuristics. The interface system 160 receives one or more queries from the online system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses from the model serving system 160 and synthesizes a response to the query on the external data. While the online system 140 can generate a prompt using the external data as context, often times, the amount of information in the external data exceeds prompt size limitations configured by the machine-learned language model. The interface system 160 can resolve prompt size limitations by generating a structured index of the data and offers data connectors to external data sources.

FIG. 1B illustrates an example system environment for an online system 140, in accordance with one or more embodiments. The system environment illustrated in FIG. 1B includes a user client device 100, a picker client device 110, a source computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 or the interface system 160 is managed by a separate entity from the online system 140. In one embodiment, as illustrated in the example system environment in FIG. 1B, the model serving system 150 or the interface system 160 is managed and deployed by the entity managing the online system 140.

FIG. 2 illustrates an example system architecture for an online system 140, in accordance with some embodiments. The system architecture illustrated in FIG. 2 includes a data collection module 200, a content presentation module 210, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user's interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from a source computing system 120, a picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online system 140, a user rating for the picker, which sources the picker has collected items at, or the picker's previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and offers the orders to pickers for service based on picker data. For example, the order management module 220 offers an order to a picker based on the picker's location and the location of the source from which the ordered items are to be collected. The order management module 220 may also offer an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. For example, the machine learning module 230 may train the item selection model, the availability model, or any of the machine-learned models deployed by the model serving system 150. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

With respect to the machine-learned models hosted by the model serving system 150, the machine-learned models may already be trained by a separate entity from the entity responsible for the online system 140. In another embodiment, when the model serving system 150 is included in the online system 140, the machine-learning training module 230 may further train parameters of the machine-learned model based on data specific to the online system 140 stored in the data store 240. As an example, the machine-learning training module 230 may obtain a pre-trained transformer language model and further fine tune the parameters of the transformer model using training data stored in the data store 240. The machine-learning training module 230 may provide the model to the model serving system 150 for deployment.

FIG. 3 is a flowchart for an example method of generating retailer clusters using a large language model, in accordance with some embodiments. Alternative embodiments may include more, fewer, or different steps from those illustrated in FIG. 3 or the steps may be performed in a different order from that illustrated in FIG. 3.

The online system accesses 300 user data stored by the online system. User data is data describing characteristics of a user. For example, user data may include data describing the user's demographics and the user's interactions with the online system 140. The online system may also access contextual data describing a user's session with the online system. For example, the contextual data may describe which items a user has interacted with during the session or search queries that have been entered by the user.

The online system accesses 310 item source data for a set of item sources. Item source data for an item source is data describing the item source. For example, the item source data for an item source may include a catalog of items that are available at the item source or locations associated with the item source. The item source data includes item interaction data describing interactions made by users with items associated with the item source. For example, the item interaction data may describe interaction rates of items associated with the item source, where the interaction rate describes how many interactions have occurred with items associated with the item source within a time period. The interaction data may describe interactions made by users within item source locations or may describe interactions made through the online system. In some embodiments, the interaction data includes sales data describing sales to users by the item source.

The online system generates item source clusters for presentation to a user through a client device. An item source cluster is a set of item sources that are related to each other based on a theme. For example, an item source cluster may cluster together item sources that have items related to a holiday, related to an activity, or share some characteristic (e.g., healthy or vegetarian). A description for an item source cluster is text that describes the theme to which the set of item sources relate. For example, a description of an item source cluster may be a title or short paragraph that explains to a user what the theme for the item source cluster is.

To generate an input prompt for an LLM to generate item source clusters, the online system generates a set of tags for each of the item sources described in the item source data. To generate these tags, the online system accesses 320 an item taxonomy for each of the item sources. The item taxonomies are hierarchical data structures that describe categories and subcategories of items at different levels of generality that are available for purchase at an item source. Different levels in the taxonomy may provide different levels of specificity about the items included in the levels. For example, nodes of the item taxonomy closer to a root node of the item taxonomy may represent broader categories than nodes closer to leaves. In some embodiments, different levels in the taxonomy identify items with differing levels of specificity based on any suitable attribute or combination of attributes of the items. For example, different levels of the taxonomy may specify different combinations of attributes for items, so items in lower levels of the hierarchical taxonomy have a greater number of attributes corresponding to greater specificity, while items in higher levels of the hierarchical taxonomy have a fewer number of attributes, corresponding to less specificity in a category. In various embodiments, higher levels in the taxonomy include less detail about items, so greater numbers of items are included in higher levels (e.g., higher levels include a greater number of items satisfying a broader category). Similarly, lower levels in the taxonomy include greater detail about items, so fewer numbers of items are included in the lower levels (e.g., higher levels include a fewer number of items satisfying a more specific category). The taxonomy may be received from an item source or may be generated by the online system based on an item catalog received from the item source.

The online system selects 330 a set of categories for each item source from the categories and subcategories represented in the taxonomy. The online system selects the set of categories for an item source based on interaction data for items within categories represented in the taxonomy. For example, the online system may select categories that have interaction rates associated with them that exceed a threshold value. In some embodiments, the online system selects categories within different levels of generality of the item taxonomy. For example, if an item taxonomy has five levels of generality, the online system may select categories within each (or each of a subset of) of the five levels of generality. The online system may rank the categories within levels of the taxonomy based on their corresponding interaction rates and identify the top n categories within those levels. The online system also may simply find the top n categories across all levels of generality of the taxonomy.

In some embodiments, the online system normalizes interaction rates based on the relative numbers of items within categories or within levels of generality of the taxonomy. For example, the online system may compute an interaction rate for each of a set of categories and then normalize (e.g., divide) each interaction rate based on the number of items within each category, thereby ensuring that an interaction rate for a category is not inappropriately high or low for having many or few items, respectively.

FIG. 4 illustrates example categories selected within an example item taxonomy, according to some embodiments. In the illustrated item taxonomy 400, the leaf nodes 410 represent individual items and their ancestor nodes 420 represent categories of items. Each node also includes an interaction rate 430, which is a numerical value representing a quantity of interactions with an item or with items in a corresponding category. The online system selects categories 440 of items within the item taxonomy based on the interaction rates 430 of the nodes.

The online system generates 340 one or more tags for each selected category. A tag is a text string that describes each category. For example, the online system may generate the tag “produce” for a category representing produce items. The online system may generate the tag for a category based on text data stored in the item taxonomy. For example, nodes in the taxonomy may include text information describing a corresponding category. Similarly, the online system may use information stored in the item taxonomy to generate new tags. For example, the online system may use information describing items for a category to generate tags for the category. In some embodiments, the online system uses an LLM to generate tags for categories. For example, the online system may prompt an LLM with information describing items within a category and instruct the LLM to generate a text string for a tag for the category.

The online system generates 350 an input prompt for a LLM of the model serving system. The input prompt instructs the LLM to identify an item source cluster based on the generated tags for the item sources by identifying a subset of the item sources to present together to a user. The input prompt may also include parameters for the item source cluster. For example, the input prompt may specify how many item sources to select for the item source cluster or whether certain tags or item sources should be prioritized. The input prompt may further include a diversity requirement that specifies that the LLM should identify sources with a sufficiently diverse set of tags. For example, the input prompt may require that sources within a cluster should not have overlapping tags, that only a threshold number of sources have overlapping tags, or that the sources in the cluster include a threshold number of unique tags.

The input prompt includes the generated tags and the accessed user data for use by the LLM to perform the instructed tasks. The input prompt may further include item source data describing the item sources or may include context data for the user's session with the online system.

The input prompt may also include instructions to generate a description for the item source cluster. The input prompt may also specify parameters for the description, such as what kind of description to generate (title vs. short summary) or how long the description should be (e.g., how many words). The input prompt also may specify whether the LLM should generate a description for each of the item sources selected for the item cluster or for the cluster as a whole.

The online system transmits 360 the prompt to the LLM and receives 370 a response from the LLM. The received response indicates which item sources were selected for the item source cluster, and may also include a description for the item source cluster to be displayed. For example, the response may list the subset of item sources to present as the item source cluster or may list scores for each of the set of item sources.

The online system transmits the subset of item sources and the generated description to a client device for presentation 380 through a user interface to the user. For example, the online system may cause the user client device to present a user interface that displays the item sources together (e.g., in a carousel user interface element or a banner user interface element) along with the generated description. In some embodiments, the online system displays the tags for the item sources in the user interface along with the item sources. The user can interact with the item source cluster through the user interface (e.g., select an item source from which to order items).

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed by a computer system comprising a processor and a computer-readable medium, comprising:
accessing user data describing a user of an online system;
accessing source data for a plurality of item sources, wherein the source data comprises interaction rate data describing interactions of users of the online system with items associated with each of the plurality of item sources during a time period;
generating a plurality of tags for each of the plurality of item sources, wherein each tag comprises a text string describing a characteristic of a corresponding item source, and wherein the plurality of tags are generated for an item source by:
accessing an item taxonomy for the item source, wherein the item taxonomy is a hierarchical data structure that describes categories of items at a plurality of levels of generality;
selecting a set of categories representing the item source based on the item taxonomy and the interaction rate data; and
generating the plurality of tags for the item source based on the selected set of categories;
generating a prompt for a model serving system, wherein the prompt comprises:
the plurality of tags for each item source of the plurality of item sources;
the accessed user data;
the accessed source data;
instructions to identify a subset of item sources of the plurality of item sources to present to the user based on the user data, the source data, and the plurality of tags for each item source of the plurality of item sources; and
instructions to generate a description of the subset of item sources based on the user data, the source data, and the plurality of tags for each item source of the plurality of item sources;
transmitting the prompt to the model serving system;
receiving a response from the model serving system, wherein the response comprises the subset of item sources and the description of the subset of item sources; and
transmitting the subset of item sources and the description of the subset of item sources to a client device of the user for display.

2. The method of claim 1, wherein selecting the set of categories comprises:
selecting one or more categories from each of a subset of the plurality of levels of generality of the item taxonomy.

3. The method of claim 2, wherein selecting one or more categories from a level of generality comprises:
ranking categories within the level of generality based on interaction rate data for each of the categories within the level of generality; and
selecting the one or more categories based on the ranking.

4. The method of claim 2, wherein selecting one or more categories from a level of generality comprises:
identifying one or more categories within the level of generality with interaction rate data exceeding a threshold value.

5. The method of claim 1, wherein selecting the set of categories comprises:
normalizing interaction rate data for the selected set of categories based on a number of items within each of the selected set of categories.

6. The method of claim 1, wherein generating the plurality of tags for the item source comprises:
accessing a text description for each of the set of categories stored by the online system; and
generating the plurality of tags based on the text description for each of the set of categories.

7. The method of claim 1, wherein generating the plurality of tags comprises:
prompting a model serving system to generate the plurality of tags based on item data for items in the set of categories.

8. The method of claim 1, wherein the instructions to identify a subset of item sources comprise instructions to generate a score for each of the plurality of item sources based on the plurality of tags, the user data, and the source data.

9. The method of claim 1, wherein the instructions to identify the subset of item sources comprise instructions to identify item sources that do not have overlapping tags.

10. The method of claim 1, wherein the instructions to generate a description of the subset of item sources comprise instructions to generate a title for the subset of item sources.

11. A non-transitory computer-readable medium storing instructions that, when executed by a computer system:
accessing user data describing a user of an online system;
accessing source data for a plurality of item sources, wherein the source data comprises interaction rate data describing interactions of users of the online system with items associated with each of the plurality of item sources during a time period;
generating a plurality of tags for each of the plurality of item sources, wherein each tag comprises a text string describing a characteristic of a corresponding item source, and wherein the plurality of tags are generated for an item source by:
accessing an item taxonomy for the item source, wherein the item taxonomy is a hierarchical data structure that describes categories of items at a plurality of levels of generality;
selecting a set of categories representing the item source based on the item taxonomy and the interaction rate data; and
generating the plurality of tags for the item source based on the selected set of categories;
generating a prompt for a model serving system, wherein the prompt comprises:
the plurality of tags for each item source of the plurality of item sources;
the accessed user data;
the accessed source data;
instructions to identify a subset of item sources of the plurality of item sources to present to the user based on the user data, the source data, and the plurality of tags for each item source of the plurality of item sources; and
instructions to generate a description of the subset of item sources based on the user data, the source data, and the plurality of tags for each item source of the plurality of item sources;
transmitting the prompt to the model serving system;
receiving a response from the model serving system, wherein the response comprises the subset of item sources and the description of the subset of item sources; and
transmitting the subset of item sources and the description of the subset of item sources to a client device of the user for display.

12. The computer-readable medium of claim 11, wherein selecting the set of categories comprises:
selecting one or more categories from each of a subset of the plurality of levels of generality of the item taxonomy.

13. The computer-readable medium of claim 12, wherein selecting one or more categories from a level of generality comprises:
ranking categories within the level of generality based on interaction rate data for each of the categories within the level of generality; and
selecting the one or more categories based on the ranking.

14. The computer-readable medium of claim 12, wherein selecting one or more categories from a level of generality comprises:
identifying one or more categories within the level of generality with interaction rate data exceeding a threshold value.

15. The computer-readable medium of claim 11, wherein selecting the set of categories comprises:
normalizing interaction rate data for the selected set of categories based on a number of items within each of the selected set of categories.

16. The computer-readable medium of claim 11, wherein generating the plurality of tags for the item source comprises:
accessing a text description for each of the set of categories stored by the online system and
generating the plurality of tags based on the text description for each of the set of categories.

17. The computer-readable medium of claim 11, wherein generating the plurality of tags comprises:
prompting a model serving system to generate the plurality of tags based on item data for items in the set of categories.

18. The computer-readable medium of claim 11, wherein the instructions to identify a subset of item sources comprise instructions to generate a score for each of the plurality of item sources based on the plurality of tags, the user data, and the source data.

19. The computer-readable medium of claim 11, wherein the instructions to identify the subset of item sources comprise instructions to identify item sources that do not have overlapping tags.

20. A computer system comprising a processor and a non-transitory computer-readable medium storing instructions that, when executed by the computer system, cause the computer system to perform operations:
accessing user data describing a user of an online system;
accessing source data for a plurality of item sources, wherein the source data comprises interaction rate data describing interactions of users of the online system with items associated with each of the plurality of item sources during a time period;
generating a plurality of tags for each of the plurality of item sources, wherein each tag comprises a text string describing a characteristic of a corresponding item source, and wherein the plurality of tags are generated for an item source by:
accessing an item taxonomy for the item source, wherein the item taxonomy is a hierarchical data structure that describes categories of items at a plurality of levels of generality;
selecting a set of categories representing the item source based on the item taxonomy and the interaction rate data; and
generating the plurality of tags for the item source based on the selected set of categories;
generating a prompt for a model serving system, wherein the prompt comprises:
the plurality of tags for each item source of the plurality of item sources;
the accessed user data;
the accessed source data;
instructions to identify a subset of item sources of the plurality of item sources to present to the user based on the user data, the source data, and the plurality of tags for each item source of the plurality of item sources; and
instructions to generate a description of the subset of item sources based on the user data, the source data, and the plurality of tags for each item source of the plurality of item sources;
transmitting the prompt to the model serving system;
receiving a response from the model serving system, wherein the response comprises the subset of item sources and the description of the subset of item sources; and
transmitting the subset of item sources and the description of the subset of item sources to a client device of the user for display.
